(19) United States
(12) Patent Application Publication
(10) Pub. No.: US 2009/0288897 A1
(43) Pub. Date: Nov. 26, 2009

(54) Radiator Bracket With Integrated Hood Pin Receptacle

(76) Inventor: Adam Louramore, Margate, FL (US)

Correspondence Address: GOLD & RIZVI, P.A., 600 N. PINE ISLAND ROAD, SUITE 450, PLANTATION, FL, 33324-1311, US

(21) Appl. No.: 12/469,881

(22) Filed: May 21, 2009

Related U.S. Application Data
(60) Provisional application No. 61/054,869, filed on May 21, 2008.

(51) Int. Cl. B60K 11/04

(52) U.S. Cl. 180/68.4

(57) ABSTRACT

A radiator mounting bracket (100) is fabricated providing a body (102) having a plurality of frame mounting apertures (104) disposed upon a frame mounting section (116) of the body (102), a radiator mounting aperture (106) disposed upon a radiator mounting section (118) of the body (102), and a hood pin receiving aperture (110) disposed between the frame mounting apertures (104) and the radiator mounting aperture (106). A peripheral edge of the radiator mounting aperture (106) can be chamfered (108). A plurality of weight reducing stylization apertures (120) can be incorporated within the body 102). An embossment (114) is disposed about the hood pin receiving aperture (110) upon an upper surface (140) of the body (102). A hood pin (130) is assembled to the bracket (100) via threading (112, 136).

### CROSS-REFERENCE TO RELATED APPLICATION

This application claims the benefit of co-pending U.S. Provisional Patent Application Ser. No. 61/054,869, filed on May 21, 2008, which is incorporated herein in its entirety.

### BACKGROUND OF THE INVENTION

1. Field of the Invention

The present invention relates generally to a radiator mounting bracket. More particularly, the present invention relates to a radiator upper mounting bracket incorporating a threaded receptacle for a hood locking pin.

2. Background of the Invention

The aftermarket automotive industry is fueled by the desire for speed and beauty, thus the majority of the aftermarket performance components target either the drive train or aesthetics. Examples of drive train components include carburetors, fuel injectors, air filters, pistons, blowers or superchargers, camshafts, computer chips or reprogramming systems, transmission related components, suspension enhancements, exhaust related components, wheels, brakes, and the like. Examples of aesthetic components include body styling kits such as: aerodynamic kits, fender flares, door hinge kits, rear wings, front air dams, and enhanced lighting designs; interior enhancements such as: custom seats, carpeting, gauges, steering wheels, peddles, shifters, audio/visual kits, and alarm systems; and engine compartment kits such as engine covers, wiring kits, valve covers, air filter covers, billet pulleys, and other miscellaneous billet or polished components.

Being more distinct, hood pins are one component provided in the aftermarket industry. Hood pins are generally used for race vehicles, providing a secure, light weight hood closure mechanism, while providing quick access to the engine compartment when required. The hood pins are commonly mounted to a frame cross member of the vehicle and project upwards through a port drilled through the hood of the vehicle. This mounting scheme requires the installer to drill a hole through the cross member, weakening the cross member. One of the components of a racecar is the stiffness of the chassis and overall vehicle. A weakened cross member can reduce the stiffness of the vehicle. In fact, most racecars incorporate a shock tower cross member specifically to stiffen the vehicle. Additionally, the mounting configuration through the cross member can be difficult. Further, owners prefer to avoid drilling holes through the vehicle where possible, particularly frame or structural members. Conversely, the hoods are normally replaced and the owner maintains the factory hood in showroom condition.

Therefore, a preferred mounting configuration for a hood pin is needed wherein the hood pin is mounted in a more convenient configuration.

### SUMMARY OF THE INVENTION

The invention is directed to a radiator mounting bracket further comprising a hood pin receptacle.

In one general aspect of the present invention, the radiator mounting bracket may include:

a radiator mounting bracket body, the body comprising an upper surface and a lower surface;

at least one mounting bracket aperture disposed proximate a frame mounting end of the bracket body;

a radiator mounting aperture disposed proximate a radiator mounting end of the bracket body; and

a hood pin receiving aperture formed through the radiator mounting bracket body.

In a further aspect of the present invention, a radiator mounting bracket may include a chamfer about the circumference of the radiator mounting aperture.

In still a further aspect of the present invention, the pin receptacle is threaded.

While another aspect of the present invention incorporates an embossment about the pin receptacle.

In yet another aspect of the present invention, the profile of the bracket can provide a first thickness proximate a frame mounting section of the bracket, and a second thickness proximate a radiator mounting section of the bracket, wherein the first thickness differs from the second thickness.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is an isometric view of an exemplary embodiment of a radiator mounting bracket comprising an integrated hood pin receptacle;

FIG. 2 is a top view of the radiator mounting bracket as presented in FIG. 1;

FIG. 3 is a sectional view of the radiator mounting bracket, taken along the centerline of the bracket in accordance with section 3-3 of FIG. 2;

FIG. 4 is a left side view of the radiator mounting bracket as presented in FIG. 1;

FIG. 5 is a right side view of the radiator mounting bracket as presented in FIG. 1;

FIG. 6 is a frame mounting face view of the radiator mounting bracket as presented in FIG. 1;

FIG. 7 is a radiator mounting face view of the radiator mounting bracket as presented in FIG. 1;

FIG. 8 is a front perspective view of an exemplary vehicle incorporating the inventive radiator mounting bracket;

FIG. 9 is an elevation view of the exemplary vehicle incorporating the inventive radiator mounting bracket; and

FIG. 10 is a partially sectioned view detailing the installation of the radiator mounting bracket.

### DETAILED DESCRIPTION OF REPRESENTATIVE EMBODIMENTS

Shown throughout the Figures, the invention is directed to a radiator mounting bracket comprising a hood pin receptacle.

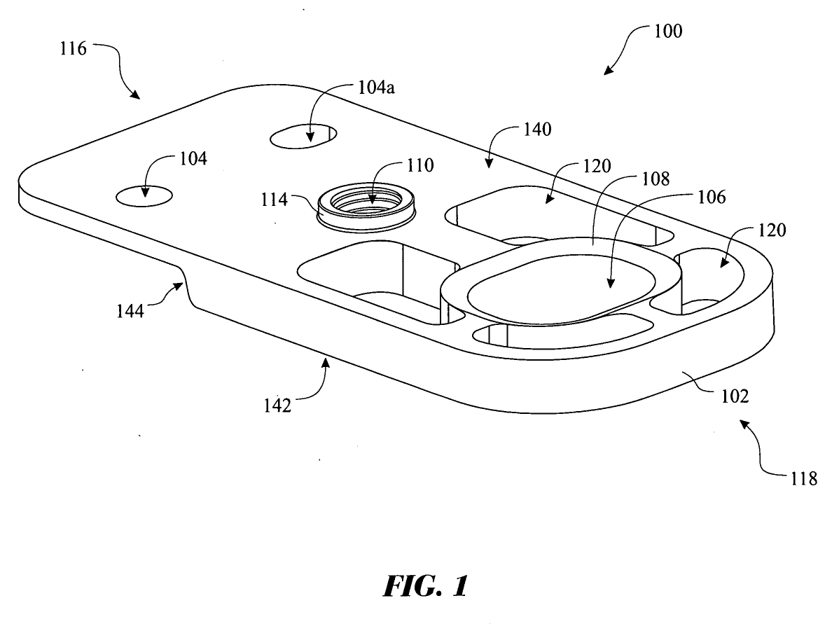

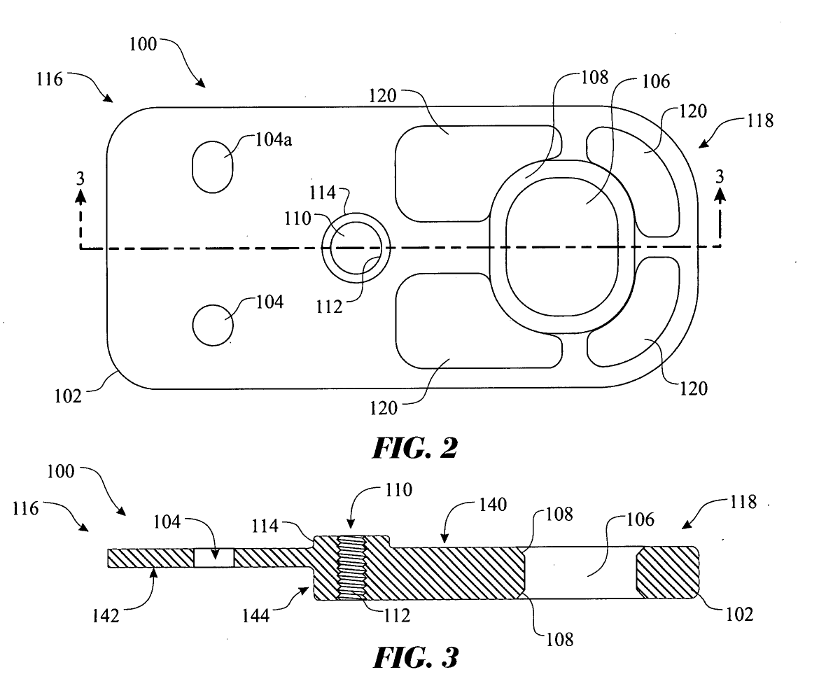

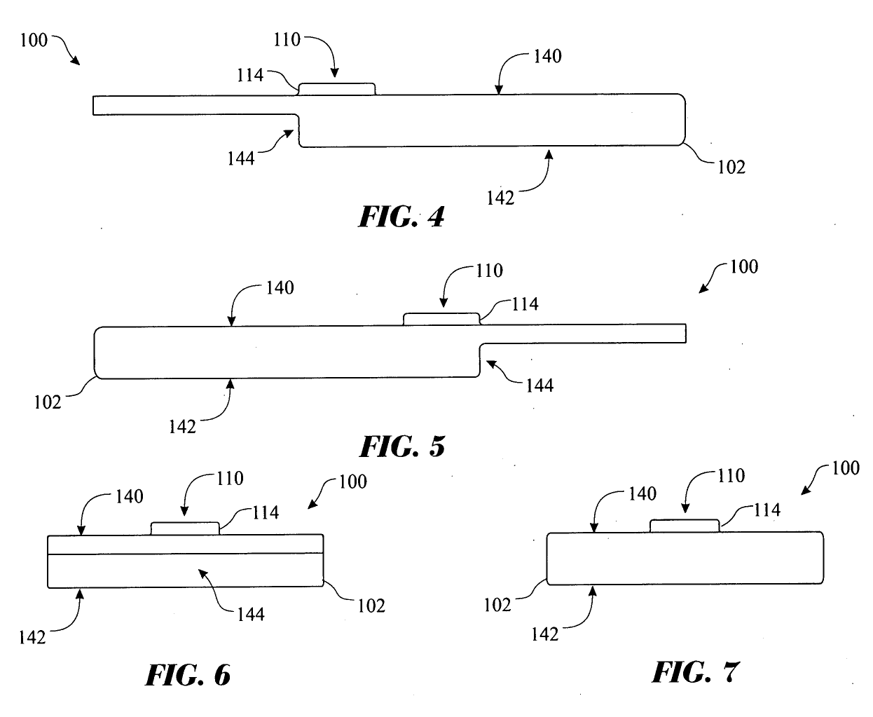

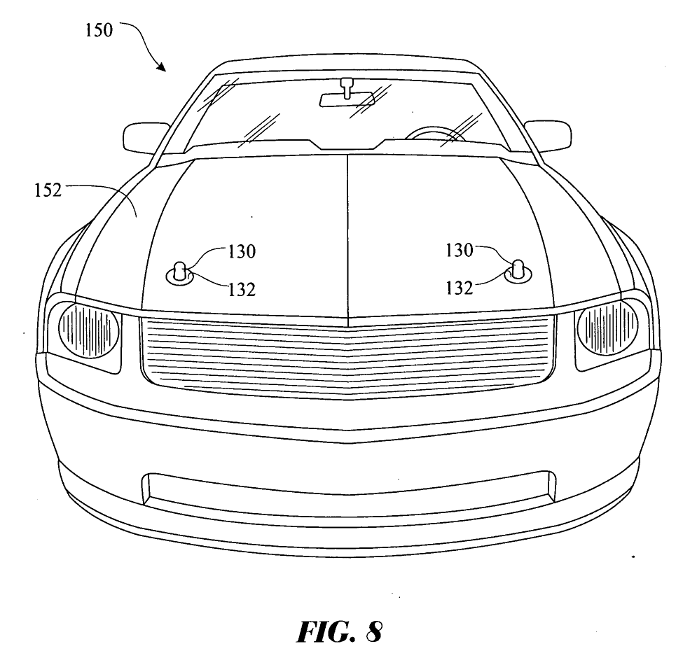

A radiator mounting bracket 100 is described herein via a plurality of views as best presented in FIGS. 1 through 7. FIG. 1 presents an isometric, top view of the radiator mounting bracket 100. A top view of the radiator mounting bracket 100 is presented in FIG. 2. A sectional view is presented in FIG. 3, the section being taken along a longitudinal centerline of the radiator mounting bracket 100 as indicated in section 3-3 of FIG. 2. Various profile views are presented in FIGS. 4 through 7: left side (FIG. 4), right side (FIG. 5), frame mounting face (FIG. 6) and a radiator mounting face (FIG. 7).

The radiator mounting bracket 100 is fabricated via machining a bracket body 102 into the designed peripheral geometry with the various features described herein. The upper 140 and lower 142 surfaces can be machined into the desired profiles, including any height compensating adjustments 144, any surface features such as a pin receiving embossment 114, and the like. The height compensating adjustment 144 provides a first thickness proximate a frame mounting section 116 and a second thickness proximate a radiator mounting section 118, wherein the first thickness differs from the second thickness. A pair of frame mounting apertures 104 are positioned proximate a frame mounting section 116 of the bracket body 102. At least one of the frame mounting apertures 104 can have an oblong shape as shown via mounting aperture 104a providing a means for tolerance compensation. A radiator mounting aperture 106 is incorporated into the radiator mounting section 118 of the bracket body 102. The apertures 104, 106 are formed through the bracket body 102 spanning from a bracket upper surface 140 through a bracket lower surface 142. A radiator mount chamfer 108 can be formed about a perimeter of the radiator mounting aperture 106, preferably on each of the two sides 140, 142 of the radiator mounting bracket 100. The chamfer can be a linear angle, an arched surface, and the like. A hood pin receiving aperture 110 is disposed through the bracket body 102 spanning from the bracket upper surface through the bracket lower surface 142. A pin receiving embossment 114 is preferably incorporated about a perimeter of the hood pin receiving aperture 110, disposed upon the bracket upper surface 140 of the radiator mounting bracket 100. A hood pin receiving threading 112 can be formed within the hood pin receiving aperture 110 for securing the hood pin (subsequently presented herein). At least one weight reducing stylization 120 can be formed within the bracket body 102 for weight reduction and aesthetics. The at least one weight reducing stylization 120 can be in any desired geometry of the designer's choice, while making engineering considerations for rigidity. The at least one weight reducing stylization 120 can be partially or completely through the bracket body 102. The bracket body can be finished in any desired manner, such as tumbling, abrading, polishing, anodizing, powder coating, painting, plating, and the like. Any machined edges can be de-burred, chamfered, rounded, and the like to remove any sharp edges. Identification markings such as part number, manufacturer, patent pending, and the like can be added as desired, using any known marking process such as laser etching, screen printing, and the like.

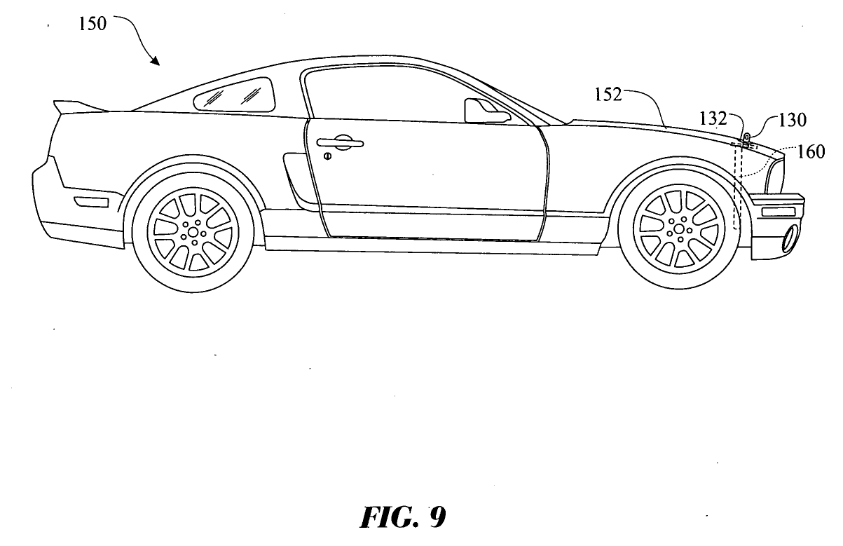

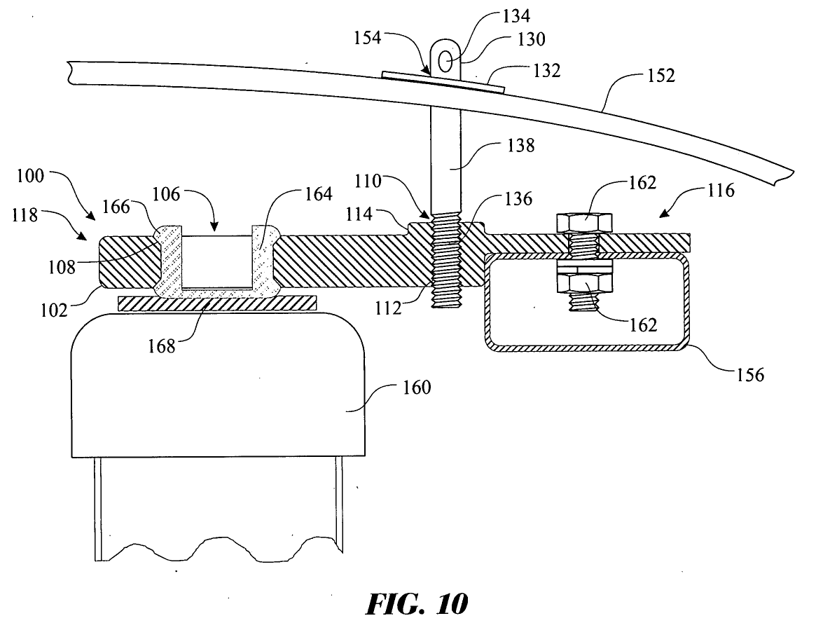

The installation of the radiator mounting bracket 100 is presented in FIGS. 8 through 10. A front view of a vehicle 150 incorporating the radiator mounting bracket 100 is presented in FIG. 8, with a side view of the vehicle presented in FIG. 9. A pair of hood pin 130 protrudes through a hood pin clearance 154 of a vehicle hood 152 of the vehicle 150. A pin backing plate 132 is disposed about the hood pin clearance 154 reinforcing and aesthetically protecting the area of the vehicle hood 152 adjacent the hood pin clearance 154. The pin backing plate 132 can be secured to the vehicle hood 152 via mechanical fasteners, adhesive, and the like. The hood pin 130 includes a pin cylindrical section 138 having a pin threaded section 136 disposed upon a mounting end of the hood pin 130. A pin receptacle 134 is formed through a hood securing end of the hood pin 130 providing a means for receiving a locking pin. The pin threaded section 136 engages with the hood pin receiving threading 112 within the hood pin receiving aperture 110 of the radiator mounting bracket 100. An upper portion of a radiator 160 is secured to the radiator mounting bracket 100 via a radiator mounting hardware 164 and an optional radiator mounting feature 168. The radiator mounting hardware 164 is inserted into the radiator mounting aperture 106, being secured via an engagement between the radiator mount flange 166 and the radiator mount chamfer 108. Although a rubber securing device such as the radiator mounting hardware 164 is shown, it is recognized that any fastening member can be utilized for securing the radiator 160 to the radiator mounting bracket 100. The radiator mounting aperture 106 would be designed respective to the selected mounting scheme. The desired mounting scheme utilizes a radiator mounting aperture 106 being an aperture through the bracket body 102. Alternate mounting schemes can be utilized wherein the radiator mounting aperture 106 is a recess disposed within the bracket lower surface 142 of the bracket body 102 and this remains within the spirit and intent of the present invention.

The bracket body 102 is secured to the vehicle 150 via at least one mounting hardware member 162 inserted through the frame mounting apertures 104 coupling the bracket body 102 to a vehicle transverse frame member 156. The elongated bracket mounting aperture 104a compensates for tolerances. The mounting hardware 162 can be of any fastening means, whereby the preferred embodiment utilizes a common bolt, nut, flat washer, and split washer.

While the preferred embodiments of the invention have been described above, it will be recognized and understood that various modifications can be made in the invention and the appended claims are intended to cover all such modifications which may fall within the spirit and scope of the invention.

I claim:

1. A radiator mounting bracket, comprising:
a radiator mounting bracket body, the body comprising an upper surface and a lower surface;
at least one mounting bracket aperture disposed proximate a frame mounting end of the bracket body;
a radiator mounting aperture disposed proximate a radiator mounting end of the bracket body; and
a hood pin receiving aperture formed through the radiator mounting bracket body.

2. A radiator mounting bracket as recited in claim 1, the hood pin receiving aperture further comprising a receiving threading disposed therein.

3. A radiator mounting bracket as recited in claim 2, the bracket further comprising a pin receiving embossment disposed upon said upper surface of said bracket body and positioned about said hood pin receiving aperture.

4. A radiator mounting bracket as recited in claim 1, the radiator mounting aperture further comprising a chamfering about a peripheral edge on at least one of the upper surface and the lower surface.

5. A radiator mounting bracket as recited in claim 1, the bracket comprising a plurality of mounting bracket apertures, wherein at least one mounting bracket aperture is round and at least one mounting bracket aperture is oblong.

6. A radiator mounting bracket as recited in claim 1, wherein the radiator mounting end is of a first thickness and the frame mounting end is of a second thickness, wherein the first thickness differs from the second thickness.

7. A radiator mounting bracket as recited in claim 1, the bracket further comprising a hood pin assembled to the hood pin receiving aperture of the radiator mounting bracket.

8. A radiator mounting bracket as recited in claim 7, wherein the hood pin is assembled to the hood pin receiving aperture via a threading.
